(19) United States
(12) Patent Application Publication
(10) Pub. No.: US 2007/0063651 A1
(43) Pub. Date: Mar. 22, 2007

(54) Plasma display panel

(76) Inventors: Hun-Suk Yoo, Suwon-si (KR); Won-Ju Yi, Suwon-si (KR)

Correspondence Address: Robert E. Bushnell, Suite 300, 1522 K Street, N.W., Washington, DC, 20005, US

(21) Appl. No.: 11/603,095

(22) Filed: Nov. 22, 2006

Related U.S. Application Data
(63) Continuation-in-part of application No. 11/071,733, filed on Mar. 4, 2005.

(30) Foreign Application Priority Data
May 1, 2004 (KR) 10-2004-0030840

(51) Int. Cl. H01J 17/49

(52) U.S. Cl. 313/583; 313/582; 313/586

(57) ABSTRACT

A plasma display panel. The plasma display panel includes barrier ribs between a first substrate and a second substrate that divide a space between into a plurality of discharge cells. Address, sustain and scan electrodes are formed within the barrier ribs and encircle ones of the discharge cells. Grooves are formed in one or both of the inner surfaces of the substrates to correspond to the discharge cells. Phosphor material is formed only in the grooves on the substrates and not on the walls of the barrier ribs.

### CROSS REFERENCE TO RELATED APPLICATIONS

This patent application makes reference to, incorporates the same herein and is a continuation-in-part of Ser. No. 11/071,733 filed in the U.S. Patent Office on Mar. 4, 2005.

### CLAIM OF PRIORITY

This application also makes reference to, incorporates the same herein, and claims all benefits accruing under 35 U.S.C. §119 from an application for PLASMA DISPLAY PANEL earlier filed in the Korean Intellectual Property Office on 1 May 2004 and thereby duly assigned Ser. No. 2004-30840.

### BACKGROUND OF THE INVENTION

1. Field of the Invention

The present invention relates to a design for a plasma display panel (PDP) capable of realizing an image using a gas discharge.

2. Description of the Related Art

A plasma display panel (PDP) has a large screen and excellent characteristics such as high picture-quality, ultra-slim size, light-weight, and wide viewing angle. The PDP can be manufactured in a simpler manner than other flat panel display devices, and the size of the PDP can be easily increased. Thus, the PDP has been important as a next-generation flat panel display device.

PDPs are categorized into DC PDPs, AC PDPs, and hybrid PDPs depending on an applied discharge voltage. PDPs are also categorized into discharge PDPs and surface discharge PDPs depending on a discharge structure. Recently, the AC PDP having an AC, three-electrode, surface-discharge structure has been widely used.

However, PDPs suffer from the problem in that the visible light must travel through a front substrate to be seen by the viewer. Because the electrodes, a dielectric layer and a protective layer are found in the front substrate, a large percentage of the visible light gets absorbed before it can be seen. As a result, the emission efficiency is low. Also, when displaying an image for a long time, the ions in the plasma tend to sputter the phosphor layers, etching in a permanent image into the display. What is needed is an improved design for a PDP that improves on emission efficiency and reduces the image bum in effect. In addition, in a method of manufacturing such a PDP, a second substrate must be prepared and then barrier ribs on which phosphor is attached must be formed, creating a complicated process. Therefore, what is also needed is a design for a PDP that is practical in that it is easy to manufacture.

### SUMMARY OF THE INVENTION

It is therefore an object of the present invention to provide a plasma display panel in which the discharge electrodes are formed within barrier ribs and phosphor layers are formed on one or both of the first substrate and the second substrate, thereby simplifying a method of manufacturing the plasma display panel.

These and other objects can be achieved by a plasma display panel that includes a first substrate and a second substrate facing each other, a plurality of barrier ribs dividing a space between the first substrate and the second substrate into a plurality of discharge cells, a plurality of first discharge electrodes arranged within the plurality of barrier ribs, extending in a first direction and surrounding ones of the plurality of discharge cells, each of the plurality of first discharge electrodes being separated from each other, a plurality of second discharge electrodes arranged within the plurality of barrier ribs and spaced apart from the plurality of first discharge electrodes by a gap, the plurality of second discharge electrodes extending in a second direction that crosses the plurality of first discharge electrodes and surrounding ones of the plurality of discharge cells, the plurality of second discharge electrodes being vertically symmetrical with respect to the plurality of first discharge electrodes, each of the plurality of second discharge electrodes being separated from each other and a phosphor layer arranged within a plurality of grooves arranged in at least one of the first substrate and the second substrate.

Each of the plurality of first discharge electrodes can include a plurality of first discharge portions that surround ones of the plurality of discharge cells and a plurality of first connection portions connecting ones of the plurality of first discharge portions together, and wherein each of the plurality of second discharge electrodes can include a plurality of second discharge portions that surround ones of the plurality of discharge cells and a plurality of second connection portions connecting ones of the plurality of second discharge portions together. A width of each first connection portion can be smaller than a width of each first discharge portion and a width of each second connection portion can be smaller than a width of each second discharge portion. A distance between first discharge portions of different ones of the plurality of first discharge electrodes can be equal to a distance between the second discharge portions within a single one of the plurality of second discharge electrodes, and a distance between second discharge portions of different ones of the plurality of second discharge electrodes can be equal to a distance between the first discharge portions within a single one of the plurality of first discharge electrodes. A side surface of the plurality of barrier ribs can be covered with a protective layer that includes MgO. Ones of the plurality of grooves can correspond to ones of the plurality of discharge cells. Depths of ones of the plurality of grooves can be smaller than a thickness of a substrate smaller than a thickness of a part of the second substrate in which the grooves are not formed. Cross-sections of ones of the plurality of grooves can correspond to cross-sections of ones of the plurality of discharge cells. The phosphor layer can be arranged on a bottom surface of each of the plurality of grooves. The phosphor layer can be arranged on a bottom surface and on a side surface of each of the plurality of grooves. Each of the plurality of grooves can be arranged in the second substrate and not the first substrate, the first substrate being a thin plate. The plurality of grooves can be arranged in each of the first substrate and the second substrate, the phosphor layer can be arranged within the plurality of grooves of both the first substrate and the second substrate in such a way that visible light can pass through the phosphor layer arranged within the grooves in the first substrate.

According to another aspect of the present invention, there is provided a plasma display panel that includes a first substrate and a second substrate facing each other, at least one of the first and the second substrates having a plurality of grooves arranged therein, a plurality of barrier ribs dividing a space between the first substrate and the second substrate into a plurality of discharge cells, ones of the plurality of discharge cells having a size, cross sectional shape and a location that corresponds to ones of the plurality of discharge cells, a plurality of first discharge electrodes arranged within the plurality of barrier ribs, extending in a first direction and surrounding ones of the plurality of discharge cells, a plurality of second discharge electrodes arranged within the plurality of barrier ribs and spaced apart from the plurality of first discharge electrodes by a gap, the plurality of second discharge electrodes extending in a second direction that crosses the plurality of first discharge electrodes and surrounding ones of the plurality of discharge cells in the second direction and a phosphor layer arranged within the plurality of grooves arranged in the at least one of the first substrate and the second substrate.

Sidewalls of the barrier ribs can be covered with an MgO protective layer. Sidewalls of the plurality of barrier ribs and a surface of the MgO protective layer can be absent of the phosphor layer. The phosphor layer can be arranged only within the grooves on the at least one of the first and the second substrates. Each of the first and the second substrates can be absent of electrodes arranged thereon.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate same or similar components, wherein:

FIG. 1 is a partly exploded perspective view of a plasma display panel (PDP);

FIG. 2 is a partly exploded perspective view of a PDP according to an embodiment of the present invention;

FIG. 3 is a plane view of the arrangement of upper discharge electrodes and lower discharge electrodes of the PDP shown in FIG. 2;

FIG. 4 is a cross-sectional view taken along line IV-IV of FIG. 2;

FIG. 5 is a cross-sectional view taken along line V-V of FIG. 2; and

FIG. 6 is a partial cross-sectional view of a PDP according to another embodiment of the present invention.

### DETAILED DESCRIPTION OF THE INVENTION

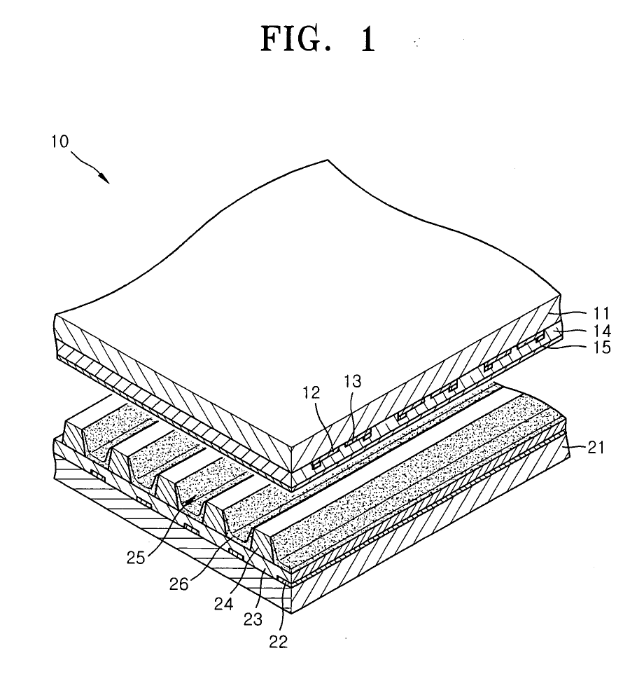

Turning now to the figures, FIG. 1 illustrates an AC, three-electrode, surface-discharge PDP 10. The PDP 10 of FIG. 1 includes a first substrate 11 and a second substrate 21 opposite the first substrate 11. Common electrodes 12 and scan electrodes 13 forming a discharge gap with the common electrodes 12 are formed on a lower surface of the first substrate 11. The common electrodes 12 and the scan electrodes 13 are buried by a first dielectric layer 14. A protective layer 15 is formed on a lower surface of the first dielectric layer 14.

Address electrodes 22 are formed on an upper surface of the second substrate 21 to overlap with the common electrodes 12 and the scan electrodes 13. The address electrodes are buried by a second dielectric layer 23. Barrier walls 24 are formed on an upper side of the second dielectric layer 23 to be separated from one another by a predetermined gap so that discharge spaces 25 are partitioned off. A phosphor layer 26 is formed in each of the discharge spaces 25, and a discharge gas is sealed in the discharge spaces 25.

In the discharge spaces 25 of PDP 10, ultraviolet rays are emitted from plasma generated by discharge. These ultraviolet rays excite the phosphor layer 26, and visible light is emitted from the excited phosphor layer 26 so that a visible image is displayed.

However, due to a structure in which the electrodes 12 and 13, the first dielectric layer 14 and the protective layer 15 are sequentially formed on the lower surface of the first substrate 11, approximately 40% visible light emitted from the phosphor layer 26 is absorbed, which prevents improvement of the emission efficiency. Furthermore, when displaying the same image for a long time, charged particles of the discharge gas ion-sputter the phosphor layer 26 by an electric field, which results in the formation of a permanent image forming and thus reducing the life-span of the PDP.

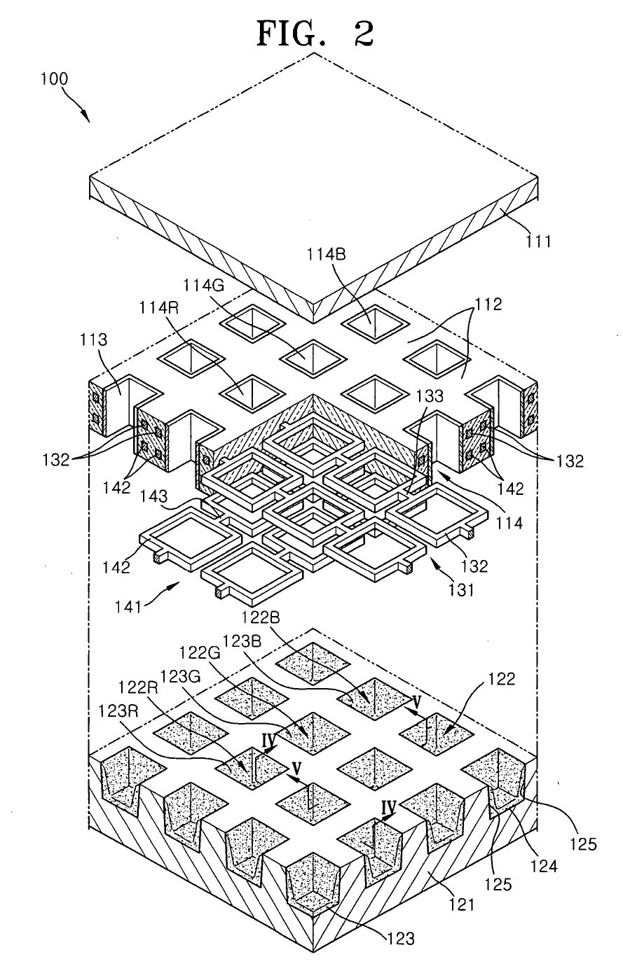

Turning now to FIGS. 2 through 5, FIGS. 2 through 5 show a plasma display panel (PDP) 100 according to an embodiment of the present invention. The PDP 100 shown in FIGS. 2 through 5 includes a first substrate 111 and a second substrate 121, which are opposite to each other. The first substrate 111 and the second substrate 121 can be made of various materials but are preferably made out of a transparent material such as glass. In particular, the first substrate 111, through which an image is displayed, is preferably made out of a material having high optical transmissivity. A plurality of barrier ribs 112 are formed between the first substrate 111 and the second substrate 121. The barrier ribs 112 divide the space between the first substrate 111 and the second substrate 121 into a plurality of discharge cells 114.

The barrier ribs 112 are arranged in the form of a lattice pattern, as shown in FIG. 2. Spaces between the barrier ribs 112 are discharge cells 114. Cross-sections of the discharge cells 114 can take various shapes according to the arrangement shape of the barrier ribs 112. For example, the cross-sections of the discharge cells 114 can take a circular shape, an elliptical shape, a polygonal shape, a triangular shape or a pentagonal shape instead of the rectangular shape shown in FIG. 2. By employing such cross sections for the discharge cells 114, the barrier ribs 112 can be arranged so that a cross-section of each of the discharge cells 114 can be a closed-type cross-section. The discharge cells 114 form a discharge space in which a discharge will occur, together with a groove 122 formed in the second substrate 121 which will be described later. The barrier ribs 112 surround the discharge cells 114, thereby serving to prevent cross-talk in which a discharge occurring in one discharge cell 114 affects adjacent discharge cells 114. Meanwhile, first discharge electrodes 131 and second discharge electrodes 141 are located within the barrier ribs 112 between the two substrates. The first discharge electrodes 131 and the second discharge electrodes 141 overlap each other and cause a discharge within the discharge cells 114.

Here, the first discharge electrodes 131 are located on an upper side of the barrier ribs 112 close to the first substrate 111, and the second discharge electrodes 141 are located on a lower side of the barrier ribs 112 and are closer to the second substrate 121 than the first discharge electrodes 131. The first discharge electrodes 131 and the second discharge electrodes 141, respectively, can be made out of a conductive metal such as aluminum, copper, or silver. Since the first discharge electrodes 131 and the second discharge electrodes 132 are arranged within the barrier ribs 112, a path through which visible light is emitted toward the first substrate 111 from the discharge cells 114 is not obstructed. Thus, the first discharge electrodes 131 and the second discharge electrodes 141 do not need to be made out of a material having a high optical transmissivity and a low conductivity such as indium tin oxide (ITO). Therefore, in the PDP 100 according to the current embodiment, a discharge response speed can be faster than PDPs that use ITO, such as the PDP 10 of FIG. 1.

The barrier ribs 112, formed around both the first discharge electrodes 131 and the second discharge electrodes 141, are made of a dielectric material. By having the barrier ribs 112 made out of a dielectric material, electricity can be prevented from flowing directly between the first discharge electrodes 131 and the second discharge electrodes 141. Also, by using a dielectric material for the barrier ribs 112, the first discharge electrodes 131 and the second discharge electrodes 141 can be prevented from being damaged from direct collision with charged particles of the plasma. Also, by forming the barrier ribs 112 out of a dielectric material, charged particles can be induced so that wall charges can easily accumulate on the barrier ribs 112. The dielectric material used in forming the first barrier ribs 112 can be PbO, B₂O₃, or SiO_{2.}

A protective layer made out of MgO is further formed on a side surfaces of the barrier ribs 112. Because of the presence of the protective layer 113, the charged particles generated during a discharge can be prevented from directly colliding with the barrier ribs 112. Thus, the barrier ribs 112 can be prevented from being damaged by ion sputtering of the charged particles generated in the plasma. In addition, when the charged particles collide with the protective layer 113, secondary electrons, which contribute to a discharge, can be emitted from the protective layer 113 so that low driving voltages can be used to produce the plasma and improved emission efficiency can be realized.

The first discharge electrodes 131 located on an upper side of the barrier ribs 112 close to the first substrate 111 are separated from each other by a predetermined gap. The first discharge electrodes 131 extend in a first direction, such as in a direction of a long side of the first substrate 111. Each first discharge electrode 131 includes portions which surround ones of a string or row of discharge cells 114 arranged in the first direction. For example, each first discharge electrode 131 can include first discharge portions 132 which surround each side of each discharge cell 114 and first connection portions 133 which connect together the first discharge portions 132, as shown in FIG. 2.

As shown in FIG. 2, the first discharge portions 132 are formed to have a predetermined width in the form of a rectangular band (e.g. a rectangular frame or rectangular rim), respectively located within the barrier ribs 112 and thus can surround each side of each discharge cell 114. However, the first discharge portions 132 are not limited to a rectangular band shape, but can instead have other shapes such as circular shapes, elliptical shapes or hexagonal shapes. In addition, since the first connection portions 133 are arranged between the adjacent first discharge portions 132, the first connection portions 133 have a minimal effect on a discharge. To this end, preferably, the width of each first connection portion 133 is substantially the same as or smaller than the width of each first discharge portion 132.

The first discharge electrodes 131 respectively extend in a first direction, for example, like in a direction of a long side of the first substrate 111. The adjacent first discharge electrodes 131 are spaced apart from each other by a predetermined gap so that the first discharge electrodes 131 are electrically isolated from one another. As such, the spaces between the first discharge portions 132 of the adjacent first discharge electrodes 131 and the spaces between adjacent first discharge portions 132 are spaced apart from one another by a predetermined gap. The first discharge electrodes 131 are arranged within the barrier ribs 112 and between the first and the second substrates. The second discharge electrodes 141 are spaced apart from the first discharge electrodes 131 by a predetermined gap and are also arranged within the barrier ribs 112.

The second discharge electrodes 141 are spaced apart from the first discharge electrodes 131 in a direction perpendicular to the first substrate 111. The second discharge electrodes 141 respectively extend in a second direction that crosses the first discharge electrodes 131, like in a direction of a short side of the first substrate 111. The second discharge electrodes 141 include portions that surround each side of each discharge cell 114 arranged in a string in the second direction in which the second discharge electrodes 141 extend. For example, one second discharge electrode 141 can include second discharge portions 142 which surround each side of each discharge cell 114 in a row extending in the second direction and second connection portions 143 which connect together the second discharge portions 142, as shown in FIG. 2.

The second discharge portions 142 can surround the circumference of the discharge cells 114 and have a predetermined width and have a rectangular band shape, as shown in FIG. 2. However, the second discharge portions 142 are not limited to the rectangular band shape shown in FIG. 2 but can have a variety of shapes, such as circular shapes, elliptical shapes or hexagonal shapes. In addition, since the second connection portions 143 are arranged between the adjacent second discharge portions 142, preferably, the second connection portions 143 minimize an effect on a discharge. To this end, preferably, the width of each second connection portion 143 is substantially the same as or smaller than the width of each second discharge portion 142.

The second discharge electrodes 141 respectively extend in a second direction, for example, like in a direction of a short side of the first substrate 111. Adjacent second discharge electrodes 141 are spaced apart from one another by a predetermined gap so that the second discharge electrodes 141 are electrically isolated from one another. As such, the spaces between the second discharge portions 142 of adjacent second discharge electrodes 141 and the spaces between adjacent second discharge portions 142 are spaced apart from one another by a predetermined gap.

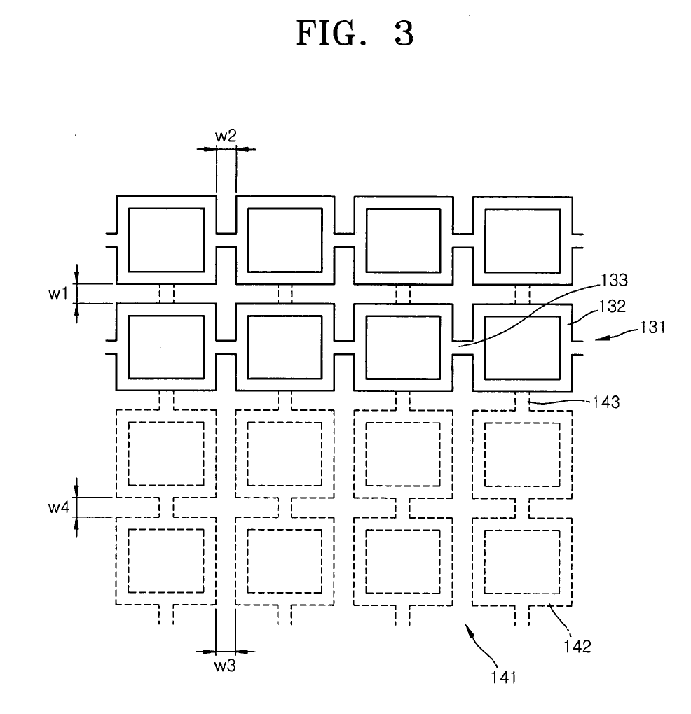

As illustrated in FIGS. 3 through 5, in the first discharge electrodes 131 and the second discharge electrodes 141 having the above structure, spaces between the first discharge portion 132 and the second discharge portion 142 located in each discharge cell 114 are vertically symmetrical with one another in that they are symmetrical with one another in a direction perpendicular to the first substrate 111. Vertically symmetrical means the first discharge portion 132 and the second discharge portion 142 are vertically symmetrical with one another within a range in which process errors generally occur in a process of manufacturing the first discharge portions 132 and the second discharge portions 142.

As illustrated in FIG. 3, the first discharge portions 132 and the second discharge portions 142 are formed to substantially the same width. A distance w1 between adjacent first discharge electrodes 131 is the same as a distance w4 between adjacent second discharge portions 142 within a single second discharge electrode 141. In addition, a distance w3 between adjacent second discharge electrodes 141 is the same as a distance w2 between adjacent first discharge portions 132 within a single first discharge electrode 131.

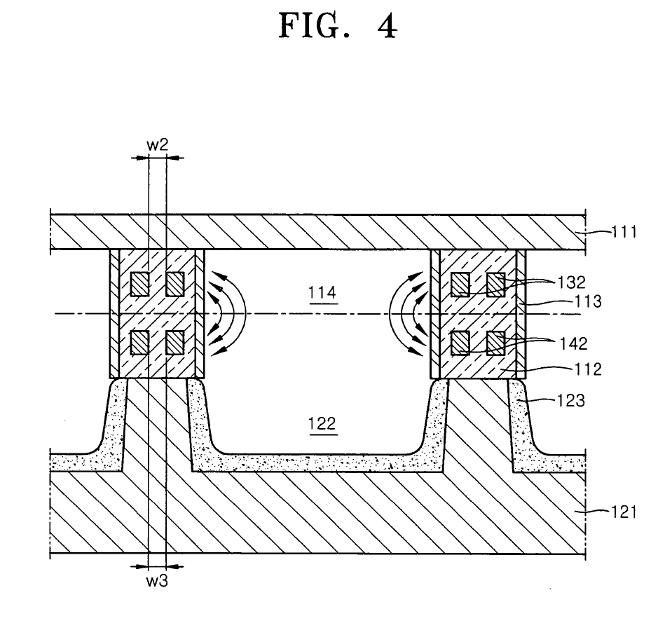

Turning now to FIG. 4, FIG. 4 is a cross section of the PDP 100 of FIG. 2 taken along IV-IV. As shown in FIG. 4, the width and height of the first discharge portions 132 are the same as those of the second discharge portions 142, respectively. In addition, a distance w2 between the first discharge portions 132 within a single first discharge electrode 131 is the same as a distance w3 between the second discharge portions 142 of adjacent second discharge electrodes 141, as described above, so that the spaces between the first discharge portions 132 and the second discharge portions 142 are symmetrical with one another based on a transverse axis indicated by a horizontal dotted line in FIG.4.

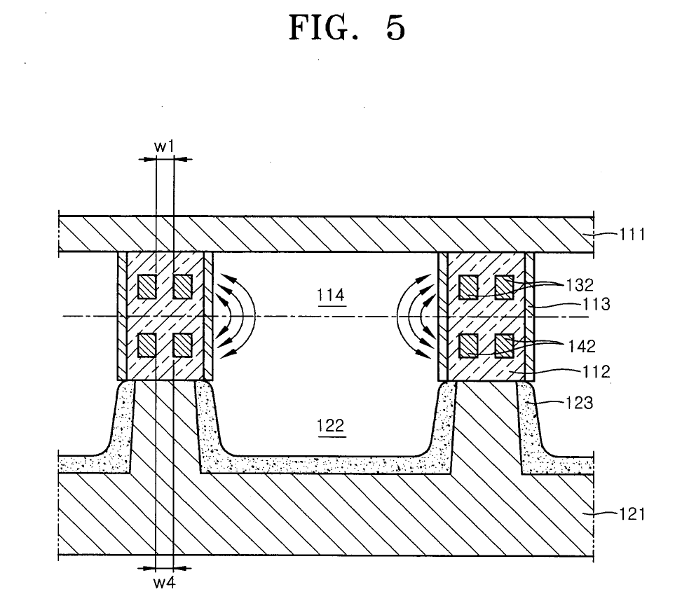

Turning now to FIG. 5, FIG. 5 is a cross section of PDP 100 of FIG. 2 taken along line V-V. As illustrated in FIG. 5, the width and height of the first discharge portions 132 are the same as the width and height respectively of the second discharge portions 142. In addition, a distance w1 between the first discharge portions 132 is the same as a distance w4 between the second discharge portions 142, as described above, so that the spaces between the first discharge portions 132 and the second discharge portions 142 are vertically symmetrical with one another based on a transverse axis indicated by a horizontal dotted line in FIG. 5.

Thus, anyone of the first discharge electrodes 131 and the second discharge electrodes 141 having the above structure acts as an address and sustain electrode, and the other one acts as a scan and sustain electrode. For example, when the first discharge electrode 131 acts as the address and sustain electrode and the second discharge electrode 141 acts as the scan and sustain electrode, if an address voltage is applied to the first discharge electrode 131 and a scan voltage is applied to the second discharge electrode 141, an address discharge occurs in the discharge cell 114 corresponding to a cross point between the first discharge electrode 131 and the second discharge electrode 141. After the address discharge occurs, if a sustain voltage is alternately applied between the first discharge electrode 131 and the second discharge electrode 141, the charged particles move in a vertical direction and a sustain discharge occurs so that an image can be displayed.

In this discharge, the spaces between the first discharge electrodes 131 and the second discharge electrodes 141 are symmetrical with one another based on the transverse axis so that a stable electric field can be formed. Thus, a discharge can be stably achieved in a discharge process in which a discharge starts at a discharge gap and diffuses therefrom in each of the discharge cells 114 along a discharge electrode.

As shown in FIG. 4, the sustain discharge that occurs between the first discharge electrodes 131 and the second discharge electrodes 141 having the above structure is essentially concentrated on an upper side of the discharge cell 114 and on all sides by which the discharge cell 114 is defined in a vertical direction. In addition, the sustain discharge that has occurred on all sides of the discharge cell 114 occurs gradually from a center of the discharge cell 114.

Thus, a discharge area becomes larger than that of the PDP 10 of FIG. 1. The size of an area in which a sustain discharge occurs is increased compared to a discharge area of the PDP 10 of FIG. 1, and a discharge volume of the area in which a sustain discharge occurs is also increased. Thus, space charges in a discharge cell 114 that are ordinarily not used can contribute to emission in the PDP 100. As such, the amount of plasma generated during a discharge can be increased so that low-voltage driving can be achieved. Meanwhile, ultraviolet rays are emitted from the discharge gas during the sustain discharge excite a phosphor layer located in the groove 122 so that visible light can be generated from the excited phosphor layer and a visible image can then be realized.

A phosphor layer 123 is arranged in each of a plurality of grooves 122 formed in the second substrate 121. The plurality of grooves 122 formed in the second substrate 121 are positioned to correspond to each discharge cell 114 defined by the barrier ribs 121, as shown in FIG. 2. One groove 122 defines a lower side of a corresponding discharge cell 114 so that one discharge space can be formed. The depth of each groove 122 is smaller than a thickness of a part of the second substrate 121 in which the grooves 122 are not formed. Preferably, the depth of each groove 122 is a depth at which visible light can be effectively emitted from the phosphor layer 123 formed in each groove 122 from the ultraviolet rays generated by a discharge. For example, the depth of each groove 122 can be about 100 to 130 μm. The cross-section of each groove 122 preferably has a shape that corresponds to the cross-section of each discharge cell 114, as shown in FIGS. 4 and 5. The grooves 122 can be formed in the second substrate 121 using a variety of methods. For example, the grooves 122 can be formed by etching the second substrate 121. An etch process that is usually performed as a semiconductor process can be used to etch the grooves 122 in the second substrate 121. The phosphor layer 123 is arranged inside each groove 122.

The phosphor layer 123 is excited by the ultraviolet rays generated during a sustain discharge and emits visible light. The phosphor layer 123 can be formed only on a bottom surface 124 of the groove 122. However, preferably, the phosphor layer 123 is formed on the bottom surface 124 as well as on a side surface 125 of each groove 122 because the phosphor layer 123 can then emit a larger amount of visible light. The phosphor layer 123 is excited by the ultraviolet rays generated during a discharge and includes phosphors that emit visible light of colors such as red, green, and blue. For example, a red phosphor layer 123R formed in a groove 122R corresponding to a red discharge cell 114R emitting red visible light includes phosphor such as Y(V,P)0₄:Eu, a green phosphor layer 123G formed in a groove 122G corresponding to a green discharge cell 114G emitting green visible light includes phosphor such as Zn₂SiO₄:Mn or YBO₃:Tb, and a blue phosphor layer 123B formed in a groove 122B corresponding to a blue discharge cell 114b emitting blue visible light includes phosphor such as BAM:Eu. Since the phosphor layer 123 is spaced apart from each discharge cell 114 by being arranged in grooves 122 of second substrate 121 instead of being located on the barrier ribs 121 in which the first and second discharge electrodes 131 and 141 are arranged, the phosphor layer 123 is not apt to be damaged by the sputtering of ions of a plasma during discharge. Thus, a life span of the phosphor layer 123 is improved, and even though a still image is realized for a long time, as the residual image phenomena is remarkably reduced. In addition, since the phosphor layer 123 is arranged inside the groove 122 of the second substrate 121 and not on the barrier ribs 112, the barrier ribs 112 can be designed to have a reduced thickness resulting in a slimmer design for the PDP 100 as a whole. Also, by not forming phosphor layers 123 on the barrier ribs 112 reduces the complexity of making the PDP 100 since the process of making the barrier ribs 112 no longer requires the step of applying a phosphor layer thereto. Instead, the application of the phosphor layer can be relegated to the formation of the substrate 121. This is significant as the manufacture of the barrier ribs, even without the application of phosphors, is complex enough as the discharge electrodes must be formed within. By relegating the application of phosphor layers to the making of the substrates instead of the making of the barrier ribs, the overall process of making the PDP 100 is greatly simplified and the cost of making is reduced.

A discharge gas is filled in each groove 122 in which the phosphor layer 123 is arranged and within each discharge cell 114 defined by the barrier ribs 112. The discharge gas can be a gas in which xenon (Xe) for generating ultraviolet rays and neon (Ne) for serving as a buffer are mixed. Since a discharge electrodes and a dielectric layer are not formed on the first substrate 111 as in the first substrate 11 of PDP 10 of FIG. 1, the thickness of the first substrate 111 can be made smaller than that of the first substrate 11 of FIG. 1. Preferably, the first substrate 111 is a thin plate within the limits in which the first substrate 111 can withstand a discharge in the discharge cells 114. By doing so, the first substrate 111 can be made smaller so that the entire thickness of the PDP 100 can be smaller and transmissivity of light is remarkably improved, resulting in increasing brightness.

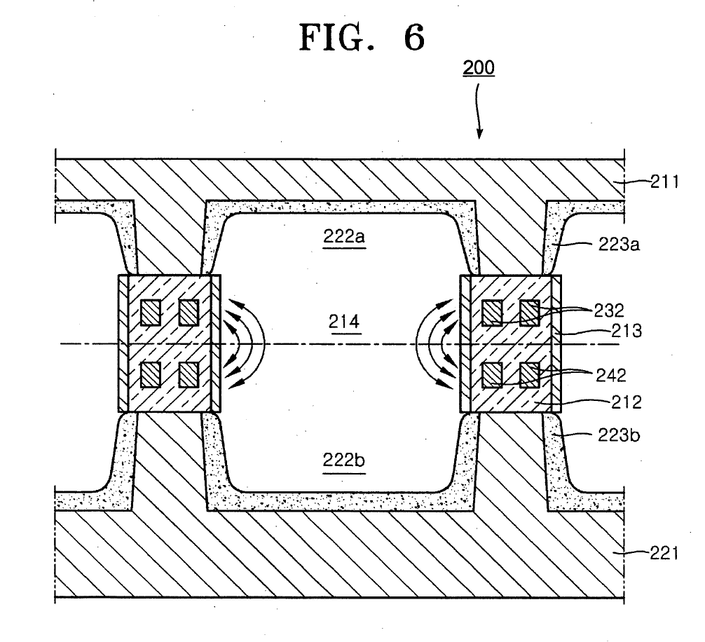

Turning now to FIG. 6, FIG. 6 is a partly cross-sectional view of a PDP 200 according to another embodiment of the present invention. The PDP 200 of FIG. 6 is different from the PDP 100 shown in FIGS. 2 through 5 in that grooves 222a and 222b in which phosphor layers 223a and 223b are formed are arranged in a first substrate 211 as well as in a second substrate 221. Thus, the PDP 200 of FIG. 6 will be described in association with this difference.

The first substrate 211 includes a plurality of grooves 222a corresponding to discharge cells 214, as shown in FIG. 6. Since the first substrate 211 includes the grooves 222a like the second substrate 221, the first substrate 211 is preferably made out of glass having a predetermined thickness. One groove 222a formed in the first substrate 211 defines an upper side of a corresponding discharge cell 214 and one groove 222b formed in the second substrate 221 defines a lower side of this corresponding discharge cell 214, thereby forming one discharge space. The depth of each groove 222a is smaller than the thickness of a part of the first substrate 211 in which the groove 222a is not formed. Preferably, the depth of each groove 222a can be properly adjusted so that the phosphor layer 223 formed within the groove 222a can emit visible light effectively and the visible light can effectively pass through the first substrate 211. The depth of each groove 222a formed in the first substrate 211 can be smaller than the depth of each groove 222b formed in the second substrate 221, for example, can be equal to or less than 100 μm. The cross-section of each groove 222a can have a shape corresponding to the cross-section of each discharge cell 214. The grooves 222a can be formed in the first substrate 211 using various methods. For example, the grooves 222a can be formed by etching the first substrate 211. In this case, an etch process that is usually performed in a semiconductor process can be used to etch the grooves 222a in the first substrate 211. The phosphor layer 223a can be arranged inside each groove 222a.

Visible light can pass through the phosphor layer 223a arranged inside the grooves 222a formed in the first substrate 211. Preferably, the materials used in phosphor layer 223a are carefully chosen to have a high transmissivity of visible light allowing the displayed image to be viewed with little attenuation. A material used in forming the phosphor layer 223a, a thickness thereof, and an applied surface can be determined in consideration of these matters.

In the PDP 200 of FIG. 6, barrier ribs 212 are covered with a protective layer 213. A gas discharge occurs within the discharge cells 214 when a voltage applied between a first discharge electrode 232 and a second discharge electrode 242 buried within the barrier ribs 212. The phosphor layer 223b formed in the groove 222b of the second substrate 221 is excited by the ultraviolet rays and visible light is emitted therefrom that propagates towards the first substrate 211. The visible light passes through the phosphor layer 223a formed in the groove 222a of the first substrate 211 and then is emitted to the outside. In addition, the phosphor layer 223a formed in the groove 222a of the first substrate 211 is excited by the ultraviolet rays and visible light is produced in phosphor layer 223a which propagates to the outside. As such, in the PDP 200 of FIG. 6, the entire amount of visible light generated can be increased and the increased amount of visible light can be transmitted to the outside such that display brightness is remarkably increased.

In the PDP 200 of FIG. 6, since a phosphor layer is formed on the substrates and not on the barrier ribs, the entire process of manufacturing PDP 200 is simplified. This is because an electrode-disposing process and a phosphor layer-depositing process are ordinarily included in a process of manufacturing barrier ribs. However, in the PDP 200 of the present invention, the process of depositing a phosphor layer on the barrier ribs is omitted in the process of making the barrier ribs. Furthermore, since the process of manufacturing barrier ribs can include only the electrode-disposing process and not the phosphor depositing process, the process of manufacturing barrier ribs of the present invention can be both simplified rapidly achieved. By relegating the deposition of the phosphor layers to the formation of the substrates, the process of making PDP 200 can be simplified and manufacturing costs can be reduced.

As described above, the PDP according to the present invention has the following advantages. First, the first discharge electrodes and the second discharge electrodes are vertically symmetrical with respect to one another and are both located within the barrier ribs allowing for a stable electric field to form. As such, a discharge stability can be guaranteed. Second, since electrodes and dielectric layers are not on or in the first substrate through which visible light must pass, an aperture ratio becomes higher resulting in improved visible light transmission characteristics of the first substrate. Third, since a discharge occurs on all sides which surround the discharge cell, a discharge area is remarkably enlarged such that low-voltage driving can be achieved. Fourth, since the phosphor layer can also be formed together with the substrate during manufacturing, a process of manufacturing a PDP can be simplified. Fifth, since the phosphor layer is formed on the substrate, the difficult process of applying a phosphor layer to the barrier ribs is avoided. Thus, the thickness of the PDP can be made small. Sixth, since only electrodes are arranged in the barrier ribs, the electrodes can be freely designed to be advantageous in producing a discharge.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. A plasma display panel, comprising:
a first substrate and a second substrate facing each other;
a plurality of barrier ribs dividing a space between the first substrate and the second substrate into a plurality of discharge cells;
a plurality of first discharge electrodes arranged within the plurality of barrier ribs, extending in a first direction and surrounding ones of the plurality of discharge cells, each of the plurality of first discharge electrodes being separated from each other;
a plurality of second discharge electrodes arranged within the plurality of barrier ribs and spaced apart from the plurality of first discharge electrodes by a gap, the plurality of second discharge electrodes extending in a second direction that crosses the plurality of first discharge electrodes and surrounding ones of the plurality of discharge cells, the plurality of second discharge electrodes being vertically symmetrical with respect to the plurality of first discharge electrodes, each of the plurality of second discharge electrodes being separated from each other; and
a phosphor layer arranged within a plurality of grooves arranged in at least one of the first substrate and the second substrate.

2. The plasma display panel of claim 1, wherein each of the plurality of first discharge electrodes comprise a plurality of first discharge portions that surround ones of the plurality of discharge cells and a plurality of first connection portions connecting ones of the plurality of first discharge portions together, and wherein each of the plurality of second discharge electrodes comprise a plurality of second discharge portions that surround ones of the plurality of discharge cells and a plurality of second connection portions connecting ones of the plurality of second discharge portions together.

3. The plasma display panel of claim 2, wherein a width of each first connection portion is smaller than a width of each first discharge portion and a width of each second connection portion is smaller than a width of each second discharge portion.

4. The plasma display panel of claim 2, wherein a distance between first discharge portions of different ones of the plurality of first discharge electrodes is equal to a distance between the second discharge portions within a single one of the plurality of second discharge electrodes, and a distance between second discharge portions of different ones of the plurality of second discharge electrodes is equal to a distance between the first discharge portions within a single one of the plurality of first discharge electrodes.

5. The plasma display panel of claim 1, wherein a side surface of the plurality of barrier ribs is covered with a protective layer that includes MgO.

6. The plasma display panel of claim 1, wherein ones of the plurality of grooves correspond to ones of the plurality of discharge cells.

7. The plasma display panel of claim 1, wherein depths of ones of the plurality of grooves are smaller than a thickness of a substrate smaller than a thickness of a part of the second substrate in which the grooves are not formed.

8. The plasma display panel of claim 1, wherein cross-sections of ones of the plurality of grooves correspond to cross-sections of ones of the plurality of discharge cells.

9. The plasma display panel of claim 1, wherein the phosphor layer is arranged on a bottom surface of each of the plurality of grooves.

10. The plasma display panel of claim 1, wherein the phosphor layer is arranged on a bottom surface and on a side surface of each of the plurality of grooves.

11. The plasma display panel of claim 1, wherein each of the plurality of grooves are arranged in the second substrate and not the first substrate, the first substrate being a thin plate.

12. The plasma display panel of claim 1, wherein the plurality of grooves are arranged in each of the first substrate and the second substrate, the phosphor layer being arranged within the plurality of grooves of both the first substrate and the second substrate in such a way that visible light can pass through the phosphor layer arranged within the grooves in the first substrate.

13. A plasma display panel, comprising:
a first substrate and a second substrate facing each other, at least one of the first and the second substrates having a plurality of grooves arranged therein;
a plurality of barrier ribs dividing a space between the first substrate and the second substrate into a plurality of discharge cells, ones of the plurality of discharge cells having a size, cross sectional shape and a location that corresponds to ones of the plurality of discharge cells;
a plurality of first discharge electrodes arranged within the plurality of barrier ribs, extending in a first direction and surrounding ones of the plurality of discharge cells;
a plurality of second discharge electrodes arranged within the plurality of barrier ribs and spaced apart from the plurality of first discharge electrodes by a gap, the plurality of second discharge electrodes extending in a second direction that crosses the plurality of first discharge electrodes and surrounding ones of the plurality of discharge cells in the second direction; and
a phosphor layer arranged within the plurality of grooves arranged in the at least one of the first substrate and the second substrate.

14. The plasma display panel of claim 13, wherein sidewalls of the barrier ribs are covered with an MgO protective layer.

15. The plasma display panel of claim 14, the sidewalls of the plurality of barrier ribs and a surface of the MgO protective layer being absent of the phosphor layer.

16. The plasma display panel of claim 13, the phosphor layer being arranged only within the grooves on the at least one of the first and the second substrates.

17. The plasma display panel of claim 13, each of the first and the second substrates being absent of electrodes arranged thereon.
